(19) United States
(12) Patent Application Publication
(10) Pub. No.: US 2012/0006135 A1
(43) Pub. Date: Jan. 12, 2012

(54) Wheel rim transmission mechanism

(76) Inventor: Yao-Tung Chen, Taoyuan County (TW)

(21) Appl. No.: 12/805,072

(22) Filed: Jul. 12, 2010

(51) Int. Cl. F16H 1/12

(52) U.S. Cl. 74/417

(57) ABSTRACT

A wheel rim transmission mechanism includes an L-shaped hollow sleeve, a transmission gear set disposed in the L-shaped hollow sleeve, and a flexible transmission shaft, so that mechanical power is generated to drive a generator to generate electric power by the transmission of a wheel rim of a traffic tool.

### BACKGROUND OF THE INVENTION

(1) Field of the Invention

The invention relates to a transmission mechanism, and more particularly to a wheel rim transmission mechanism.

(2) Description of the Prior Art

According to the statistical data of the International Energy Agency (IEA), the coal oil consumption for the traffic usage occupies 57% of the total coal oil consumption between the years of 2001 and 2003. It is predicted that the coal oil consumption for the traffic usage will exceed 60% in the year of 2010. The issue currently encountered is how to perform the technological revolution on the traffic tools having the maximum energy consumption, and to develop the new energy and systems, which have no or less contamination in the environment. At present, the vehicle and motorcycle industries spare no effort on the development of the energy-saving and environment protective traffic products including vehicles and motorcycles. However, the mode of powering the vehicle or motorcycle by the battery or the mode of increasing the percentage of the battery by recycling the electric power through the engine and the motor cannot provide the sufficient power to effectively increase the endurance of the electric traffic tool.

### SUMMARY OF THE INVENTION

In view of the forgoing background and in order to satisfy some benefit requirements in the industry, the invention provides a wheel rim transmission mechanism for achieving the object, which cannot be achieved in the prior art.

It is therefore an object of the invention to provide a wheel rim transmission mechanism including a bevel gear set and a flexible transmission shaft. The mechanism can transfer the kinetic energy to a generator through the rotation of the wheel rim, so that the generator can convert the kinetic energy into the electric power, the percentage of the battery is increased, and the endurance of the electric vehicle is increased.

The invention achieves the above-identified object by providing a wheel rim transmission mechanism including an L-shaped hollow sleeve, a first bevel gear unit, a second bevel gear unit and a flexible transmission shaft. The second bevel gear unit meshes with the first bevel gear unit in the L-shaped hollow sleeve to form a transmission gear set. The flexible transmission shaft has one end connected to the second bevel gear unit so that mechanical energy is transferred to the other end of the flexible transmission shaft with an operation of the gear set.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic illustration showing a wheel rim transmission mechanism of the invention.

FIG. 2 is a schematic illustration showing the wheel rim transmission mechanism of the invention combined with a wheel rim fixing member.

FIG. 3 is a first schematic illustration showing the wheel rim transmission mechanism of the invention applied to a traffic tool.

FIG. 4 is a second schematic illustration showing the wheel rim transmission mechanism of the invention applied to the traffic tool.

### DETAILED DESCRIPTION OF THE PREFERRED EMBODIMENTS

The present invention is directed to a transmission mechanism. In order to make the invention be completely understood, detailed structures and elements thereof will be described in the following. Obviously, the implementation of the invention is not restricted to the special details known by those skilled in the art of the transmission mechanism. On the other hand, the well-known structures and elements thereof will be not described in detail to avoid the unessential restrictions to this invention. The preferred embodiment of the invention will be described in detail in the following. In addition to the details described, the invention may also be widely applied to other embodiments, and the scope of the invention is not restricted and should be defined according to the claims.

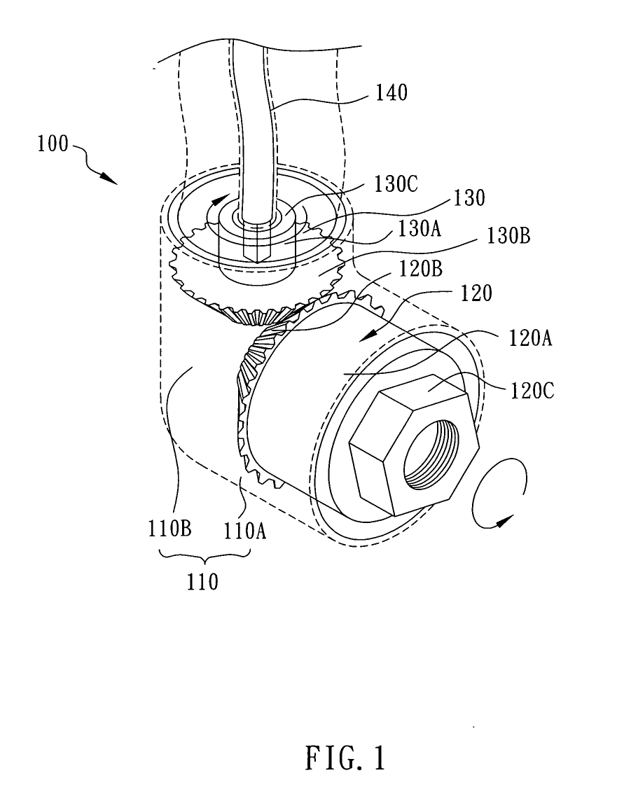

According to the first embodiment of the invention, as shown in FIG. 1, a wheel rim transmission mechanism 100 of the invention includes an L-shaped hollow sleeve 110, a first bevel gear unit 120, a second bevel gear unit 130 and a flexible transmission shaft 140. The L-shaped hollow sleeve 110 has a first sleeve arm 110A and a second sleeve arm 1108 orthogonal to and communicating with each other. The first bevel gear unit 120 and the second bevel gear unit 130 are respectively disposed in the first sleeve arm 110A and the second sleeve arm 110B of the L-shaped hollow sleeve 110. The first bevel gear unit 120 and the second bevel gear unit 130 mesh with each other in the L-shaped hollow sleeve 110 to form a transmission gear set. One end of the flexible transmission shaft 140 is connected to the second bevel gear unit 130 so that mechanical energy can be transmitted to the other end of the flexible transmission shaft 140 with the operation of the transmission gear set.

The first bevel gear unit 120 further includes a first main body 120A, a first bevel toothed portion 120B and a wheel rim connection member 120C. Two ends of the first main body 120A are respectively connected to the first bevel toothed portion 120B and the wheel rim connection member 120C. An outer side of the first main body 120A is fastened to an inner wall of the first sleeve arm 110A.

The second bevel gear unit 130 further includes a second main body 130A, a second bevel toothed portion 130B and a transmission connection member 130C. Two ends of the second main body 130A are respectively connected to the second bevel toothed portion 130B and the transmission connection member 130C. The outer side of the second main body 130A is fastened to an inner wall of the second sleeve arm 110B.

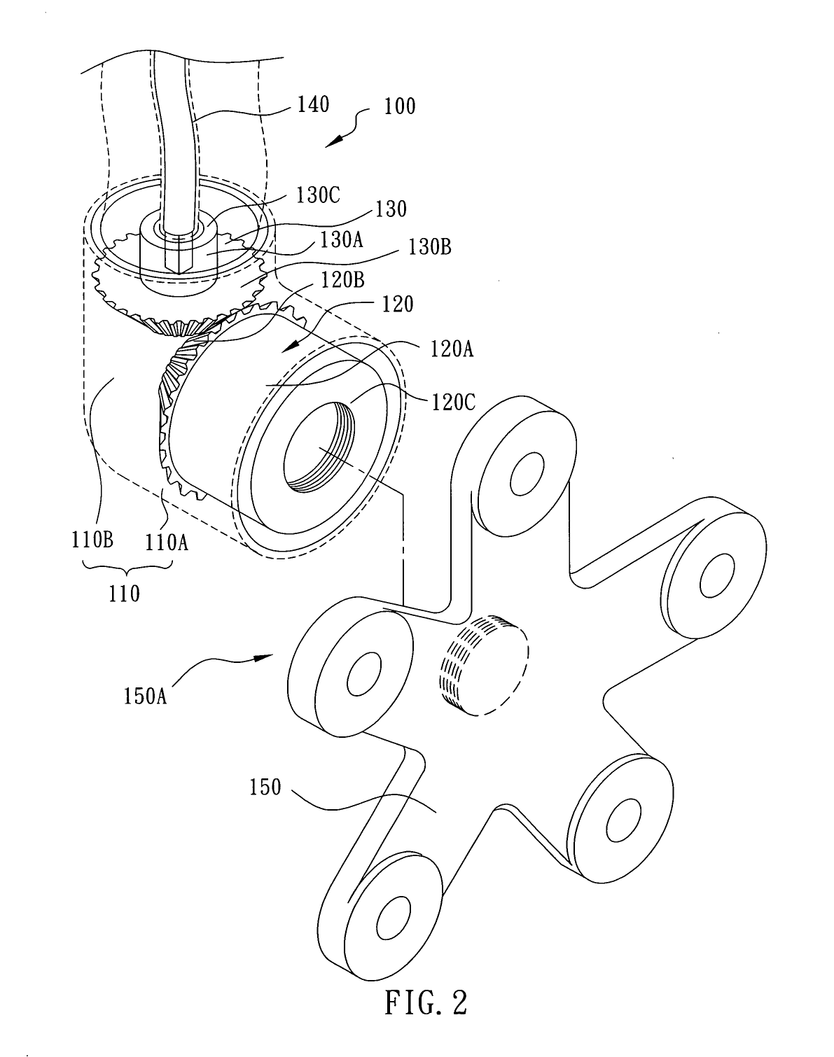

The first bevel gear unit 120 meshes with the second bevel toothed portion 130B of the second bevel gear unit 130 through the first bevel toothed portion 120B to form the transmission. The wheel rim connection member 120C of the first bevel gear unit 120 is screwed to a wheel rim fixing member 150, as shown in FIG. 2. The transmission connection member 130C of the second bevel gear unit 130 is connected to one end of the flexible transmission shaft 140.

The wheel rim fixing member 150 is screwed to the wheel rim through one of the wheel rim fixing member fulcrums 150A, and the wheel rim connection member 120C may also be directly screwed to the wheel rim. The wheel rim fixing member fulcrums 150A include at least two fulcrums.

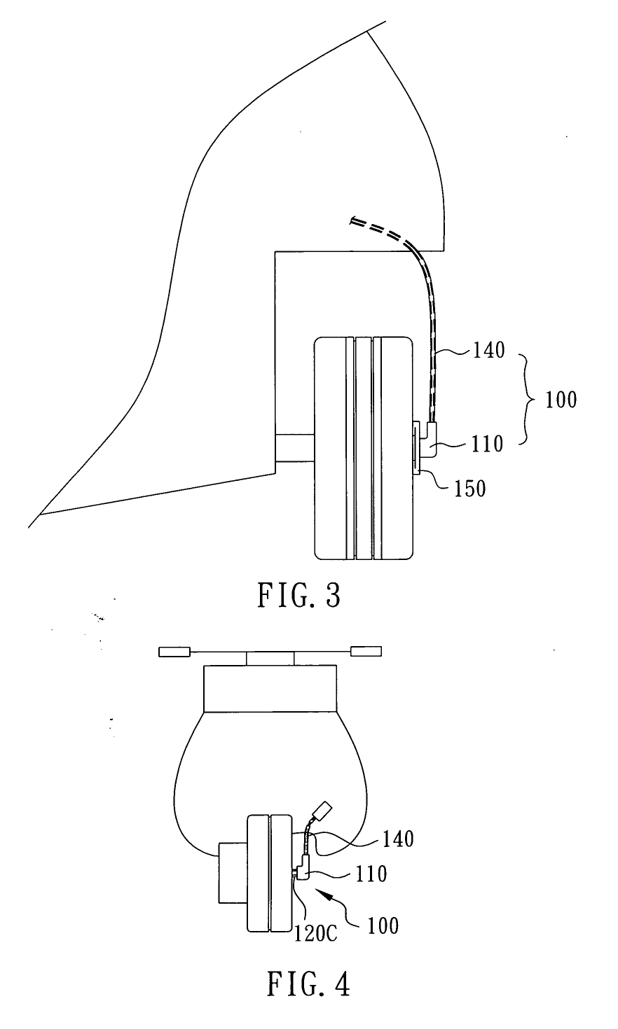

As shown in FIGS. 3 and 4, when the transmission mechanism of the traffic tool (e.g., the wheel) starts to operate, the wheel rim fixing member 150 rotates therewith rapidly, and drives the wheel rim connection member 120C screwed thereto so that the first main body 120A of the first bevel gear unit 120 is rotated rapidly, and the first bevel toothed portion 120B is simultaneously rotated. Thus, the second bevel toothed portion 130B meshing with the first bevel toothed portion 120B is rotated, the second main body 130A of the second bevel gear unit 130 is rotated, and the transmission connection member 130C on the other end of the second main body 130A is rotated. In this manner, the flexible transmission shaft 140 connected to the transmission connection member 130C is rotated, and the mechanical energy is transferred to the generator on the other end of the flexible transmission shaft 140 so that the generator converts the mechanical energy into the electric energy.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A wheel rim transmission mechanism, comprising:
an L-shaped hollow sleeve;
a first bevel gear unit;
a second bevel gear unit meshing with the first bevel gear unit in the L-shaped hollow sleeve to form a transmission gear set; and
a flexible transmission shaft having one end connected to the second bevel gear unit, so that mechanical energy is transferred to the other end of the flexible transmission shaft with an operation of the gear set.

2. The wheel rim transmission mechanism according to claim 1, wherein the L-shaped hollow sleeve has a first sleeve arm and a second sleeve arm orthogonal to and communicating with each other, and the first bevel gear unit and the second bevel gear unit are respectively disposed in the first sleeve arm and the second sleeve arm of the L-shaped hollow sleeve.

3. The wheel rim transmission mechanism according to claim 2, wherein the first bevel gear unit further comprises a first main body, a first bevel toothed portion and a wheel rim connection member, and two ends of the first main body are respectively connected to the first bevel toothed portion and the wheel rim connection member.

4. The wheel rim transmission mechanism according to claim 3, wherein the wheel rim connection member is screwed to a wheel rim fixing member, and the wheel rim connection member may be screwed to a wheel rim.

5. The wheel rim transmission mechanism according to claim 4, wherein the wheel rim fixing member is screwed to the wheel rim through one of wheel rim fixing member fulcrums, and the wheel rim fixing member fulcrums comprise at least two fulcrums.

6. The wheel rim transmission mechanism according to claim 3, wherein an outer side of the first main body is fastened to an inner wall of the first sleeve arm.

7. The wheel rim transmission mechanism according to claim 3, wherein the second bevel gear unit further comprises a second main body, a second bevel toothed portion and a transmission connection member, and two ends of the second main body are respectively connected to the second bevel toothed portion and the transmission connection member, wherein the second bevel gear unit meshes with the first bevel toothed portion of the second bevel gear unit through the second bevel toothed portion.

8. The wheel rim transmission mechanism according to claim 7, wherein the transmission connection member is connected to one end of the flexible transmission shaft.

9. The wheel rim transmission mechanism according to claim 7, wherein an outer side of the second main body is fastened to an inner wall of a second sleeve arm.

10. The wheel rim transmission mechanism according to claim 1, wherein the other end of the flexible transmission shaft is connected to a generator for converting the mechanical energy, transferred by the wheel rim transmission mechanism, into electric energy.
